(19) United States
(12) Patent Application Publication
(10) Pub. No.: US 2015/0035521 A1
(43) Pub. Date: Feb. 5, 2015

(54) PORTABLE METAL DETECTOR

(71) Applicant: Costruzioni Elettroniche Industriali Automatismi S.p.A. C.E.I.A. S.P.A., Arezzo (IT)

(72) Inventor: Alessandro Manneschi, Arezzo (IT)

(21) Appl. No.: 14/451,799

(22) Filed: Aug. 5, 2014

(30) Foreign Application Priority Data
Aug. 5, 2013 (FR) 1357790

(51) Int. Cl. G01V 3/08; G01V 3/10; G01P 15/18

(52) U.S. Cl. CPC G01V 3/081; G01P 15/18; G01V 3/10
USPC 324/228

(57) ABSTRACT

The present invention relates to a portable metal detector adapted for detection of dangerous metallic items carried by individuals, for example during access to a departure lounge in an airport, comprising a casing which houses a transmitter/receiver winding, the casing being extended by a gripping and handling handle, and a processor which feeds a loop of the winding to generate a magnetic field and which detects perturbations of the magnetic field caused by the environment, characterised in that the detector comprises a sensor for detecting orientation of the detector in a vertical position of the handle and which, when the detector is in a vertical position, activates a single dynamic detection mode of the winding whereas, when the detector is in another position, it activates a static operating mode of the winding.

### CROSS-REFERENCE TO RELATED APPLICATIONS

The present application claims benefit to French Application No. 1357790, filed Aug. 5, 2013, the disclosure of which is incorporated herein by reference.

### FIELD OF THE INVENTION

The present invention relates to the field of portable metal detectors adapted for detection of dangerous metallic items carried by individuals, for example during access to a departure lounge in an airport, or any other similar place of controlled access.

### STATE OF THE ART

Many portable metal detectors have already been proposed adapted for detection of dangerous metallic items carried by individuals.

The attached FIG. 1 illustrates by way of non-limiting example the general structure of such known sensors.

As is evident from the attached FIGS. 1 and 2, known sensors 10 generally comprise a casing 20 extended by a gripping and handling handle 30.

The casing 20 contains an electric winding 22 in the form of a loop centred about an axis 23 which extends perpendicularly to the longitudinal direction 32 of the handle 30. The winding 22 is connected to a processor 40 and a power supply 42.

The processor 40 is adapted alternatively for a) feeding the winding 22, forming a transmitter winding by electrical voltage producing a magnetic field and b) detecting, as the winding 22 forms a receiver winding, perturbations of the magnetic field resulting from metallic pieces placed in the environment of the detector.

Known sensors can form the subject of many embodiments, especially as to the geometry of the winding, the nature of the electrical voltage applied to the winding (most often high-frequency alternative electrical voltage, and preferably successively frequency scanning), and the configuration of the winding 22 (a single winding can be provided, used alternatively and sequentially at the transmitter when supplied to generate a magnetic field and at the receiver when used to detect perturbations due to the environment or at least two separate windings respectively forming transmitter and receiver).As illustrated schematically in the attached FIG. 3, portable metal detectors 10 adapted for detection of dangerous metallic items carried by an individual are most often used by a security agent SA for body-scanning a suspect individual SI, for example in airports at the access to the departure lounge, after passing through a metal-detector gantry which has indicated the possible presence of a metal object on a suspect individual SI.

### GENERAL AIM OF THE INVENTION

Based on the observation that a conventional detector is highly sensitive to the environment, especially to concrete rebar forming the supporting floor, when it is used at foot level of a suspect individual to verify that this individual is not hiding a dangerous object, for example a knife, in his shoes or socks, as shown in FIG. 4, the aim of the present invention now is to propose means for eliminating drawback.

This aim is attained according to the invention by a portable metal detector adapted for detection of dangerous metallic items carried by individuals, comprising a casing which houses a transmitter/receiver winding extended by a gripping and handling handle and a processor which feeds a loop of the winding to generate a magnetic field and which detects perturbations of the magnetic field caused by the environment, characterised in that the detector comprises an accelerometer for detecting orientation of the detector in a vertical position of the handle and which, when the detector is in a vertical position, activates a dynamic detection mode of the winding, whereas when the detector is in another position, it activates a static operating mode of the winding.

### DESCRIPTION OF FIGURES

Other characteristics, aims and advantages of the present invention will emerge from the following detailed description in relation to the attached diagrams given by way of non-limiting examples and in which:

FIGS. 1 to 4 mentioned previously schematically illustrate a known portable detector and its use,

FIG. 5 schematically illustrates a non-limiting example of a portable detector according to the present invention, and

FIG. 6 schematically illustrates a variant embodiment of the winding according to the present invention.

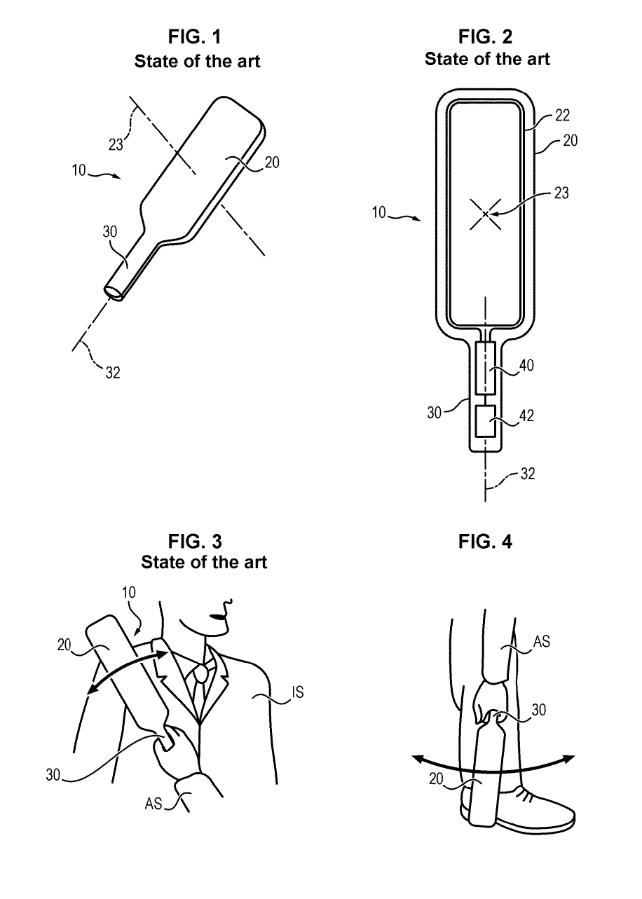

### DETAILED DESCRIPTION

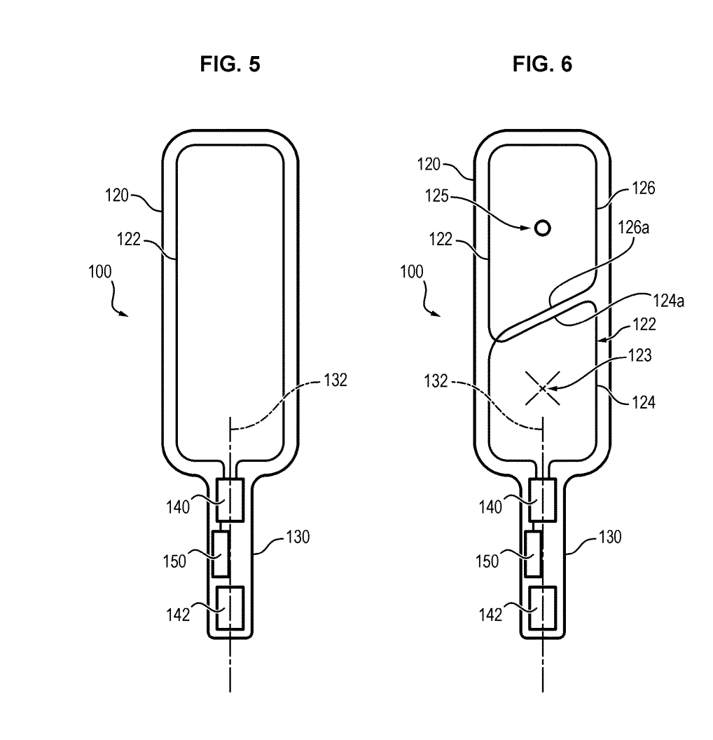

FIG. 5 schematically illustrates a sensor 100 according to the present invention comprising a casing 120 extended by gripping and handling a handle 130 which extends according to a longitudinal axis 132.

The casing 120 contains an electric winding 122.

The winding 122 is connected to a processor 140 and a power supply 142.

The processor 140 is adapted alternatively a) to feed the winding 122, forming a transmitter winding, by electrical voltage producing a magnetic field and b) detect, as the winding 122 forms a receiver winding, perturbations of the magnetic field resulting from metal pieces placed in the environment of the detector.

The winding 122 is preferably located in the median plane of the casing 120 located in the extension of the axis 132 of the handle 130, and centred about an axis 123 which extends perpendicularly to the longitudinal direction 132 of the handle 130.

The operation of the processor 140 to feed the winding 122 and successively perform detection is well known per se and therefore will not be described in any more detail hereinbelow.

As indicated previously according to the present invention, the detector also comprises a sensor 150, such as a triple-axle accelerometer, for detecting orientation of the detector in a vertical position of the handle 130 and which, when the detector is in this vertical position, activates only a dynamic detection mode of the winding 122, whereas when the detector is in another position it activates a static and operating mode dynamic of the winding 122.

<<Orientation of the detector in a vertical position of the handle 130>>means at least substantially vertical orientation, for example 15° close to the longitudinal direction 132 of the handle 130.

When just the dynamic operation of the winding 122 is activated, the processor ignores the perturbations detected which remain constant over a defined time range, whether the detector is being held in a constant position or being moved. This arrangement according to the present invention ignores perturbations due to rebar in the support flooring, but does detect a metal object carried at floor level by an individual, for example a knife, when the detector is moved at foot level of an individual.

However when dynamic and static operation of the winding 122 is activated, the processor 140 takes into account all perturbations detected, the detector being considered as being far from the floor.

The position sensors formed by a triple-axle accelerometer are known per se. They will therefore not be described in any more detail hereinbelow.

Of course, the present invention is not limited to the embodiments which just been described, but extends to all variants in keeping with its central idea.

In particular, the geometry of the winding 122 can form the object of many variant embodiments.

FIG. 6 illustrates a variant embodiment according to which the winding 122 comprises a multipolar winding in 8.

This multipolar winding 122 comprises two elementary loops 124 and 126 placed electrically in series and wound in opposite directions such that identical perturbations caused simultaneously on each elementary coil are compensated and cancelled at the output of the winding 122. The loops 124 and 126 are centred about respective axes 123, 125.

The number of turns of the two elementary loops 124 and 126 is preferably identical. Similarly, the surfaces of both elementary loops 124 and 126 are preferably identical.

Preferably, as is evident from FIG. 6, the adjacent strands 124a, 126a of the two elementary loops 124 and 126 of the winding 122, located in the median part of the winding in 8, do not extend orthogonally to the longitudinal direction 132 of the handle 130, but are inclined relative to this direction, so as not to create a neutral median zone on the magnetic plane at the level of which a metal object would not be detected. Because of the inclination of these strands 124a and 126a, it is actually guaranteed that an object placed near the middle of the winding 122 cuts field lines of the elementary coils 124, 126 when the detector is moved by scanning in an alternative pivoting movement centred about an axis centred overall on the wrist of the user and orthogonal to the direction 132.

In an embodiment, the winding 122 or inductive transducer is formed by a simple winding constituting transmitter and receiver.

In another embodiment, the transducer 122 is formed by two windings forming respectively transmitter and receiver, and is appropriate alternatively.

In all cases, the windings preferably comprise several loops in series of inverse directions for neutralising the effects of external parasites.

Also, the inductive transducer 122 can advantageously comprise windings offset to each other, both at the level of transmission and reception, to limit mutual inductance generated by the windings of the inductive transducer.

Of course, the number of transmitter windings and the number of receiver windings is not limited to one or two. Also, the number of transmitter windings is not necessarily identical to the number of receiver windings.

1. A portable metal detector adapted for detection of dangerous metallic items carried by individuals, for example during access to a departure lounge in an airport, comprising a casing which houses a transmitter/receiver winding, the casing being extended by a gripping and handling handle, and a processor which feeds a loop of the winding to generate a magnetic field and which detects perturbations of the magnetic field caused by the environment, characterised in that the detector comprises a sensor for detecting orientation of the detector in a vertical position of the handle and which, when the detector is in a vertical position, activates a single dynamic detection mode of the winding, whereas when the detector is in another position, it activates a static operating mode of the winding.

2. The detector according to claim 1, characterised in that the sensor is a triple-axle accelerometer.

3. The detector according to claim 1, characterised in that when the detector is in a position other than the vertical, the dynamic and static operation of the winding is activated.

4. The detector according to claim 1, characterised in that the winding comprises multipolar winding.

5. The detector according to claim 1, characterised in that the winding comprises two elementary loops placed electrically in series and wound in opposite directions such that identical perturbations caused simultaneously on each elementary coil are compensated and cancelled at the output of the winding.
